(19) United States
(12) Patent Application Publication
(10) Pub. No.: US 2007/0242048 A1
(43) Pub. Date: Oct. 18, 2007

(54) ELECTRONIC DEVICE AND KEYBOARD MODULE THEREOF

(75) Inventor: Jian Dong Yang, Suzhou (CN)

Correspondence Address: QUINTERO LAW OFFICE, PC, 2210 MAIN STREET, SUITE 200, SANTA MONICA, CA, 90405, US

(73) Assignee: BENQ CORPORATION, TAOYUAN (TW)

(21) Appl. No.: 11/734,219

(22) Filed: Apr. 11, 2007

(30) Foreign Application Priority Data
Apr. 12, 2006 (TW) TW95112986

(51) Int. Cl. G09G 5/00

(52) U.S. Cl. 345/169

(57) ABSTRACT

The keyboard module includes a base, a transparent layer, a light source, and a reflective layer. The base includes a dome, and the transparent layer is adjacent to the base. The light source provides light to the transparent layer. The reflective layer covers the transparent layer and has a first opening and a second opening, wherein the first opening corresponds to the dome and the second opening corresponds to the light source.

### BACKGROUND OF THE INVENTION

1. Field of the Invention

The invention relates to a keyboard module of an electronic device, and in particular, to a keyboard module with uniform brightness of a backlight.

2. Description of the Related Art

A conventional keyboard of an electronic device often comprises a backlight. The backlight provides light through the keys, allowing use of this type, in a low-light environment. In conventional keyboard modules, no means is provided to control the light's scattering and a large part of the emitted light is wasted, affecting the illumination and uniform brightness of the keys.

Thus, providing uniform brightness of the backlight without affecting the thickness of the electronic device is an important consideration.

### BRIEF SUMMARY OF THE INVENTION

The invention provides a keyboard module comprising a base, a transparent layer, a light source, and a reflective layer. The base comprises a dome, and the transparent layer is adjacent to the base. The light source provides light to the transparent layer. The reflective layer covers the transparent layer and has a first opening and a second opening, wherein the first opening corresponds to the dome and the second opening corresponds to the light source.

The transparent layer has a first surface and a second surface. The second surface is opposite the first surface. The first surface faces the base, and the first opening is on the second surface.

The transparent layer has a side surface with the light source disposed thereon.

The reflective layer covers the first surface, the second surface and the side surface of the transparent layer.

The transparent layer has a recess with the light source disposed therein.

The reflective layer is formed on the transparent layer by electroplating, printing, or evaporation deposition.

The transparent layer comprises rubber.

The reflective layer is a total reflective layer, and comprises silver, nickel, or chromium.

The dome comprises metal.

The invention provides an electronic device comprising a body, a base, a transparent layer, a light source, and a reflective layer. The base is disposed in the body and comprises a dome. The transparent layer is disposed in the body and comprises a key corresponding to the dome. The light source is disposed in the body and provides light to the transparent layer. The reflective layer covers the transparent layer, and has a first opening and a second opening, wherein the first opening corresponds to the key and the second opening corresponds to the light source.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a schematic view of an electronic device of the invention; and

FIG. 2 is a sectional view of the electronic device of the invention;

FIGS. 3A and 3B depict a first surface and a second surface of a transparent layer, respectively; and

FIGS. 4A and 4B depict a light path through a transparent layer.

### DETAILED DESCRIPTION OF THE INVENTION

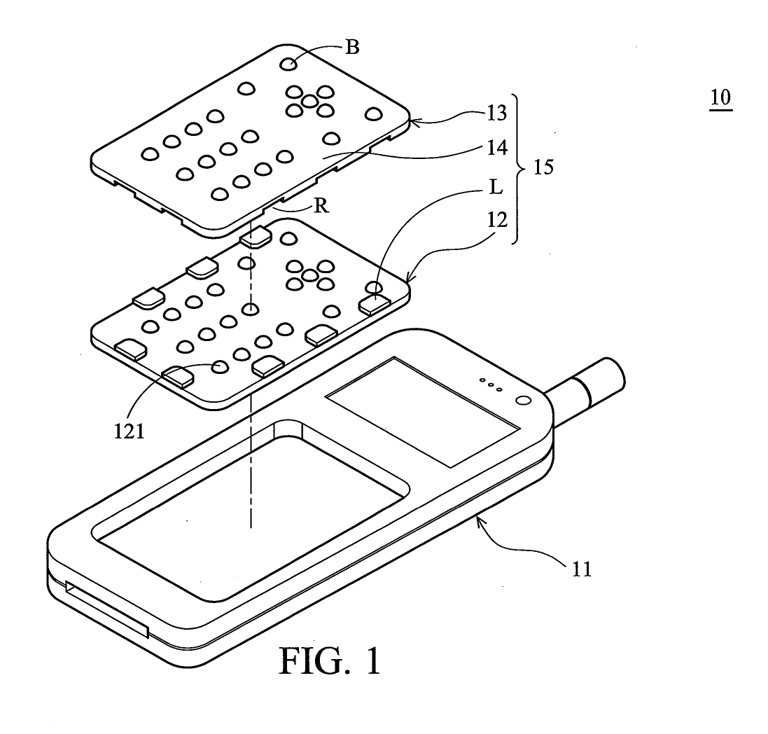

As shown in FIG. 1, the electronic device 10 of the embodiment is a mobile phone, comprising a body 11 and a keyboard module 15. The keyboard module 15 comprises a base 12, a transparent layer 13, a reflective layer 14, and a plurality of light sources L, wherein the base 12 is a circuit board.

The body 11 comprises basic constituents of a mobile phone, with a display screen, speaker, antenna, and other necessary parts disposed therein.

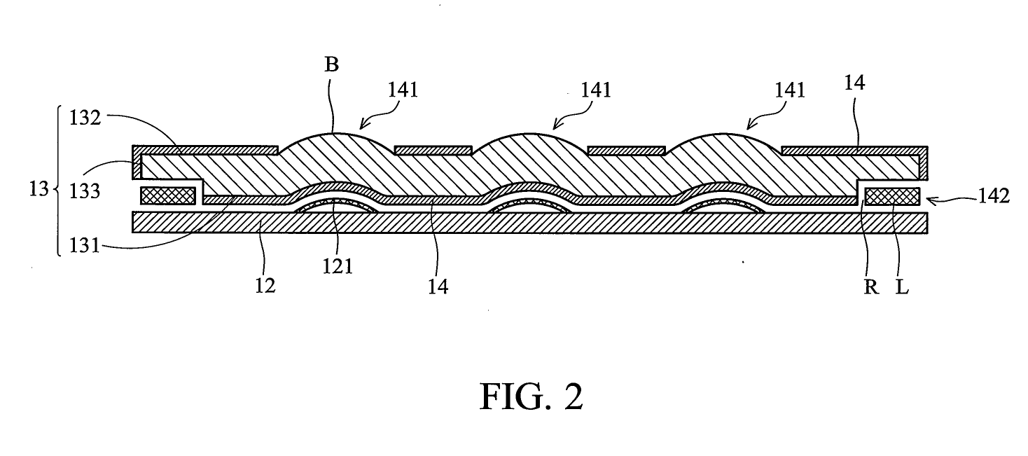

As shown in FIG. 2, the base 12 is disposed in the body 11, comprising a plurality of metal domes 121.

The transparent layer 13 is rubber, and disposed in the body 11, adjacent to the base 12. The transparent layer 13 has a first surface 131, a second surface 132, a side surface 133 and a plurality of recesses R. The first surface 131 faces the base 12, and is opposite the second surface 132. The recesses R are located between the first surface 131 and the side surface 133. The transparent layer 13 comprises a plurality of keys B, disposed on the second surface 132, wherein the keys B correspond to the domes 121 in an one-to-one manner. When the keys B are pressed, the corresponding domes 121 are deformed. The light sources L are side emitting LED's or omnidirectional emitting LED's, disposed in the recesses R, providing light to the transparent layer 13.

It should be noted that the recesses R are at the boundary of the first surface 131 and the side surface 133 in this embodiment, but the disclosure is not limited thereto. The recesses R are disposed according to disposition of the light sources L.

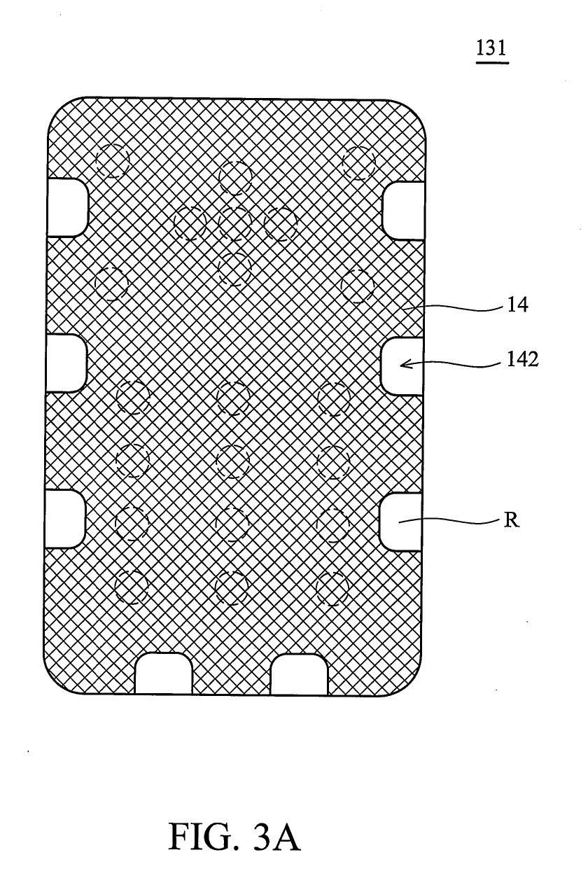

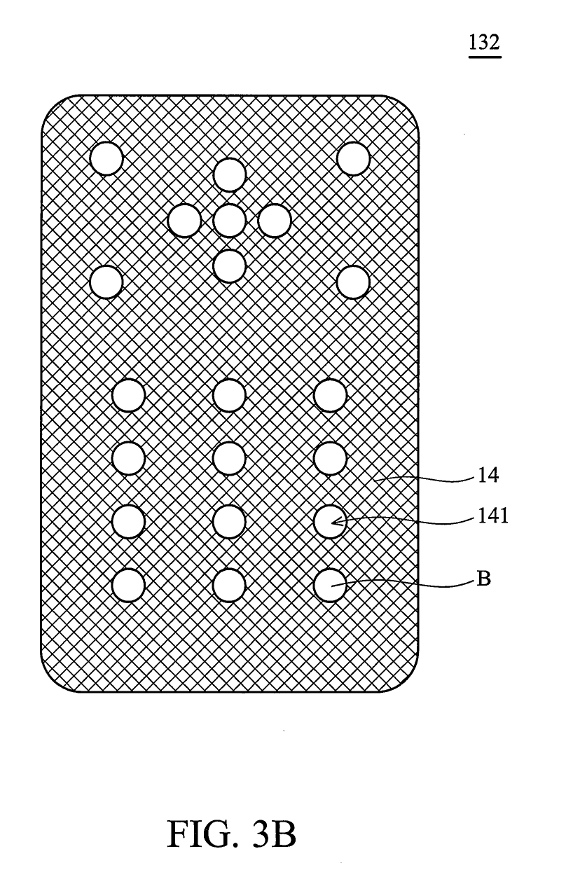

The reflective layer 14 is a total reflective layer of silver, covering the first surface 131, the second surface 132, and the side surface 133 of the transparent layer 13. The reflective layer 14 comprises a plurality of first openings 141 and a plurality of second openings 142. The first openings 141 correspond to the keys B, and the second openings 142 correspond to the light sources L or the recesses R (referring to FIGS. 3A and 3B).

It should be noted that in this embodiment, the reflective layer 14 is formed on the transparent layer 13 by electroplating, printing, or evaporation deposition with material comprising silver, nickel, or chromium, but the disclosure is not limited thereto. The reflective layer 14 can be of other reflective material, and covers the transparent layer 13 in other modifications.

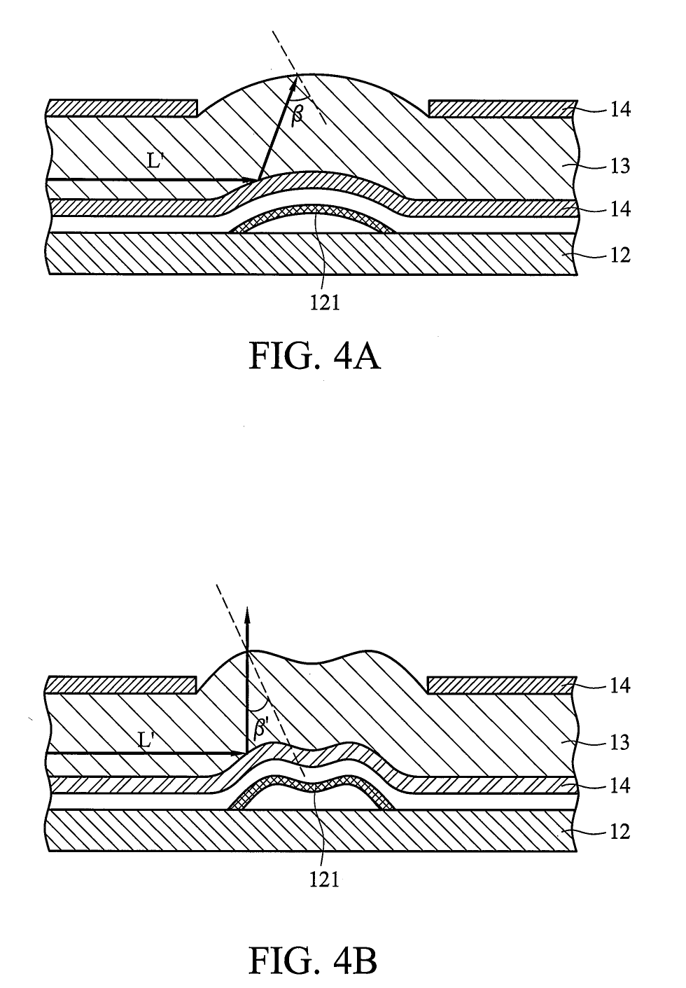

As shown in FIGS. 4A and 4B, under normal conditions, light L′ is emitted from the light source L toward a first interface (between the transparent layer 13 and the reflective layer 14), and reflected to the second interface (between the transparent layer 13 and air), forming an incident angle β. Because the incident angle β exceeds the critical angle for total reflection, light L′ fails to pass through the interface and is totally reflected, resulting in keys B dimmed. When the keys B are pressed, light L′ is emitted toward the first interface (between the transparent layer 13 and the reflective layer 14), and reflected to the second interface (between the transparent layer 13 and air). At this time, the transparent layer 13 is deformed, causing the incident angle β to decrease to β′ (as shown in FIG. 4B). Light passed through the transparent layer 13 increases, brightening keys B.

In the embodiment, the transparent layer 13 of the keyboard module 10 comprises a total reflective layer 14, such that light L′ passes only through the first opening 141, decreasing power expenditure, and enhancing luminance of the keys B. Additionally, light provided by the light sources L reflects many times in the transparent layer 13, such that every key B receives uniform illumination. When one of the keys B is pressed, the incident angle decreases to β ′, increasing light L′ through the first opening 141. The pressed key B is brighter than other keys B. As a result, the luminance and the uniform brightness of the pressed key in the embodiment are guaranteed.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A keyboard module, comprising:
a base, comprising a dome;
a transparent layer, adjacent to the base;
a light source, providing light to the transparent layer; and
a reflective layer, covering the transparent layer, having a first opening and a second opening, wherein the first opening corresponds to the dome and the second opening corresponds to the light source.

2. The keyboard module as claimed in claim 1, wherein the transparent layer has a first surface and a second surface, opposite the first surface, wherein the first surface faces the base, and the first opening is on the second surface.

3. The keyboard module as claimed in claim 2, wherein the transparent layer has a side surface with the light source disposed thereon.

4. The keyboard module as claimed in claim 3, wherein the reflective layer covers the first surface, the second surface and the side surface of the transparent layer.

5. The keyboard module as claimed in claim 1, wherein the transparent layer has a recess with the light source disposed therein.

6. The keyboard module as claimed in claim 1, wherein the reflective layer is formed on the transparent layer by electroplating, printing, or evaporation deposition.

7. The keyboard module as claimed in claim 1, wherein the transparent layer comprises rubber.

8. The keyboard module as claimed in claim 1, wherein the reflective layer is a total reflective layer.

9. The keyboard module as claimed in claim 1, wherein the reflective layer comprises silver, nickel, or chromium.

10. The keyboard module as claimed in claim 1, wherein the dome comprises metal.

11. An electronic device, comprising:
a body;
a base, disposed in the body, comprising a dome;
a transparent layer, disposed in the body, comprising a key corresponding to the dome;
a light source, disposed in the body, providing light to the transparent layer; and
a reflective layer, covering the transparent layer, having a first opening and a second opening, wherein the first opening corresponds to the key and the second opening corresponds to the light source.

12. The electronic device as claimed in claim 11, wherein the transparent layer comprises a side surface with the light source disposed thereon.

13. The electronic device as claimed in claim 11, wherein the transparent layer comprises a recess, with the light source disposed therein, and the second opening corresponds to the recess.

14. The electronic device as claimed in claim 11, wherein the reflective layer is formed on the transparent layer by electroplating, printing, or evaporation deposition.

15. The electronic device as claimed in claim 11, wherein the transparent layer comprises rubber.

16. The electronic device as claimed in claim 11, wherein the reflective layer is a total reflective layer.

17. The electronic device as claimed in claim 11, wherein the reflective layer comprises silver, nickel, or chromium.

18. The electronic device as claimed in claim 11, wherein the dome comprises metal.
